(19) United States
(12) Patent Application Publication
(10) Pub. No.: US 2020/0034081 A1
(43) Pub. Date: Jan. 30, 2020

(54) APPARATUS AND METHOD FOR PROCESSING DATA IN MEMORY SYSTEM

(71) Applicant: SK hynix Inc., Gyeonggi-do (KR)

(72) Inventor: Jong-Min LEE, Seoul (KR)

(21) Appl. No.: 16/295,635

(22) Filed: Mar. 7, 2019

(30) Foreign Application Priority Data
Jul. 25, 2018 (KR) 10-2018-0086792

(51) Int. Cl. G06F 3/06

(52) U.S. Cl. CPC G06F 3/0659; G06F 3/0673; G06F 3/0604

(57) ABSTRACT

A memory system includes a memory device and a controller. The memory device includes plural blocks, each capable of storing data. The controller records operation information used for determining which blocks among the plural blocks a voluminous data is to be programmed. The voluminous data has a size that requires at least two blocks among the plural blocks. After performing a program operation of the voluminous data, the controller can resume the program operation based on the operation information after the program operation is halted.

### CROSS-REFERENCE TO RELATED APPLICATION

This patent application claims priority to Korean Patent Application No. 10-2018-0086792, filed on Jul. 25, 2018, the entire disclosure of which is incorporated herein by reference.

### TECHNICAL FIELD

Various embodiments of the present invention generally relate to a memory system. Particularly, the embodiments relate to a memory system capable of correcting an error without performing a data recovery process after an unexpected power supply interruption, and an operation method and a control apparatus thereof.

### BACKGROUND

Recently, the computer environment paradigm has shifted to ubiquitous computing, which enables a computer system to be used anytime and everywhere. As a result, the use of portable electronic devices such as mobile phones, digital cameras, notebook computers and the like have been rapidly increasing. Such portable electronic devices typically use or include a memory system that uses or embeds at least one memory device, i.e., a data storage device. The data storage device can be used as a main storage device or an auxiliary storage device of a portable electronic device.

Unlike characteristics of a hard disk, a data storage device using a nonvolatile semiconductor memory device has advantages such as excellent stability and durability, because it has no mechanical driving part (e.g., a mechanical arm), and has high data access speed and low power consumption. As an example of a memory system having such advantages, a data storage device includes a USB (Universal Serial Bus) memory device, a memory card having various interfaces, a solid state drive (SSD) or the like.

### SUMMARY

Embodiments of the invention provide a memory system, a data processing system, and an operation process or a method, which can quickly and reliably process data into a memory device by reducing operational complexity and performance degradation of the memory system and enhancing usage efficiency of the memory device.

The memory system can perform operations for moving and programming a large amount of data stored in specific blocks such as a garbage collection or a wear levelling, in order to improve durability of the memory device. The disclosure can provide a memory system capable of executing the operation without a data recovery process even after an unexpected power supply interruption such as sudden power-off (SPO) by storing hopping information for sequentially selecting at least one memory block to be programmed, and an operation method and a control apparatus thereof. Accordingly, the memory system may not need to perform an additional data recovery process, nor simplify or reduce procedures for data recovery after sudden power-off (SPO).

Further, embodiments of the disclosure can provide a control method and a control apparatus, which may not perform an data recovery process to correct an error, in a case where a large amount of data is moved and programmed in a nonvolatile memory device and data movement or data programming is not completed due to external factors such as power supply interruption or another interruption.

In an embodiment, a memory system may include a memory device including plural blocks, each capable of storing data; and a controller suitable for recording operation information used for determining which blocks among the plural blocks a voluminous data is to be programmed, performing a program operation of the voluminous data, and resuming the program operation based on the operation information after the program operation is halted. The voluminous data can have various sizes that require at least two blocks among the plural blocks.

By the way of example but not limitation, the operation information can include a reference regarding how to determine a hopping sequence of the at least two blocks.

In the memory system, the controller can determine a specific block in which the program operation is halted, based on check point information and the operation information, between the at least two blocks.

For example, the operation information designates a second block following a first block corresponding to the check point information. The operation information can show a sequence of the at least two blocks for programming the voluminous data after the program operation is halted, even when check point information does not exist or does include an error. In an embodiment, the operation information includes metadata regarding the at least two blocks in which the voluminous data is programmed. The operation information includes a hopping rule and a first block address between the at least two blocks.

By the way of example but not limitation, a halt of the program operation is caused by a sudden power-off (SPO). The controller scans a specific block indicated by the operation information, instead of scanning all metadata in the memory device, when a power is provided after the sudden power-off.

For example, the program operation is performed during a background operation for a wear leveling of the memory device.

In another example, a method for operating a memory system can include recognizing a request or a task for programming voluminous data; recording operation information, used for determining which blocks among plural blocks of the memory system the voluminous data is to be programmed; performing a program operation of the voluminous data; and resuming the program operation based on the operation information after the program operation is undesirably halted before the program operation is completed. The voluminous data can have various sizes that require at least two blocks among plural blocks in a memory device.

By the way of example but not limitation, the operation information can include a reference regarding how to determine a hopping sequence of the at least two blocks.

The resuming the program operation can include determining a specific block in which the program operation is halted, based on check point information and the operation information, between the at least two blocks. For instance, the operation information designates a second block following a first block corresponding to the check point information.

In an example, the operation information shows a sequence of the at least two blocks for programming the voluminous data after the program operation is halted, even when check point information does not exist or does include an error. In another example, the operation information includes metadata regarding the at least two blocks in which the voluminous data is programmed. In another example, the operation information includes a hopping rule and a first block address between the at least two blocks.

By the way of example but not limitation, a halt of the program operation for the voluminous data is caused by a sudden power-off (SPO).

The resuming the program operation can include scanning a specific block indicated by the operation information, instead of scanning all metadata in the memory device, when a power is provided after the sudden power-off.

In another example, an apparatus controlling a non-volatile memory device can include a processor suitable for either performing a foreground operation in response to a command entered from a host or starting a background operation while the foreground operation is not performed; and a storage device suitable for recording operation information, used for determining which blocks voluminous data is programmed, during the background operation. The processor can perform a program operation of the voluminous data and resume the program operation based on the operation information when the program operation is undesirably halted before the program operation is completed. For example, the voluminous data may have plural sizes that require at least two blocks among plural blocks in the non-volatile memory device.

In another embodiment, a memory system can include a memory device including memory blocks and a controller coupled to the memory device. The controller can control the memory device to perform a program operation of programming, into target blocks among the memory blocks, voluminous data having a size corresponding to two or more memory blocks while recording information of a currently programmed target block among the target blocks. Further, the controller can control, after the currently programmed target block is interrupted, the memory device to resume the program operation, with reference to the currently programmed target block based on the recorded information. Information on a program order of the target blocks may be set within the controller.

### BRIEF DESCRIPTION OF THE DRAWINGS

The description herein makes reference to the accompanying drawings wherein like reference numerals refer to like parts throughout the several views, and wherein:

FIG. 1 shows an example of a data processing system including a memory system according to an embodiment of the invention;

FIG. 2 illustrates an example of a memory system according to an embodiment of the invention;

FIG. 3 shows an example of a memory device included in a memory system according to an embodiment of the invention;

FIG. 4 illustrates a non-volatile memory cell array in memory blocks included in a memory device according to an embodiment of the invention;

FIG. 5 shows a memory device structure in a memory system according to an embodiment of the invention;

FIGS. 6 and 7 illustrate an example in which a memory system according to an embodiment of the invention performs a plurality of command operations corresponding to a plurality of commands;

FIG. 8 illustrates a memory system in accordance with another embodiment of the invention;

FIG. 9 shows voluminous data movement for wear leveling;

FIG. 10 illustrates operations of free blocks selection and hopping for preparing to program large amounts of data;

FIG. 11 shows a controller according to another embodiment of the invention;

FIG. 12 illustrates a method of operating a memory system according to another embodiment of the invention; and

FIGS. 13 to 21 schematically illustrate other examples of data processing systems including a memory system according to embodiments of the invention.

### DETAILED DESCRIPTION

Various examples of the disclosure are described below in more detail with reference to the accompanying drawings. The disclosure may be embodied in other embodiments, forms and variations thereof and should not be construed as being limited to the embodiments set forth herein. Rather, the described embodiments are provided so that this disclosure is thorough and complete and will fully conveys the disclosure to those skilled in the art to which this invention pertains. Throughout the disclosure, like reference numerals refer to like parts throughout the various figures and examples of the disclosure. It is noted that reference to “an embodiment,” “another embodiment” or the like does not necessarily mean only one embodiment, and different references to any such phrase are not necessarily to the same embodiment(s).

It will be understood that, although the terms “first”, “second”, “third”, and so on may be used herein to describe various elements, these elements are not limited by these terms. These terms are used to distinguish one element from another element that otherwise have the same or similar names. Thus, a first element in one instance may be referred to as a second or third element in another instance without departing from the spirit and scope of the invention.

The drawings are not necessarily to scale and, in some instances, proportions may have been exaggerated in order to clearly illustrate features of the embodiments. When an element is referred to as being connected or coupled to another element, it should be understood that the former can be directly connected or coupled to the latter, or electrically connected or coupled to the latter via one or more intervening elements. Communication between two elements, whether directly or indirectly connected/coupled, may be wired or wireless, unless the context indicates otherwise.

In addition, it will also be understood that when an element is referred to as being “between” two elements, it may be the only element between the two elements, or one or more intervening elements may also be present.

The terminology used herein is for the purpose of describing particular embodiments only and is not intended to be limiting of the invention.

As used herein, singular forms are intended to include the plural forms and vice versa, unless the context clearly indicates otherwise. The articles ‘a’ and ‘an’ as used in this application and the appended claims should generally be construed to mean ‘one or more’ unless specified otherwise or clear from context to be directed to a singular form.

It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention pertains in view of the present disclosure. It will be further understood that terms, such as those defined in commonly used dictionaries, should be interpreted as having a meaning that is consistent with their meaning in the context of the disclosure and the relevant art and will not be interpreted in an idealized or overly formal sense unless expressly so defined herein.

In the following description, numerous specific details are set forth in order to provide a thorough understanding of the invention. The invention may be practiced without some or all of these specific details. In other instances, well-known process structures and/or processes have not been described in detail in order not to unnecessarily obscure the invention.

It is also noted, that in some instances, as would be apparent to those skilled in the relevant art, a feature or element described in connection with one embodiment may be used singly or in combination with other features or elements of another embodiment, unless otherwise specifically indicated.

Embodiments of the disclosure will be described in detail with reference to the accompanied drawings.

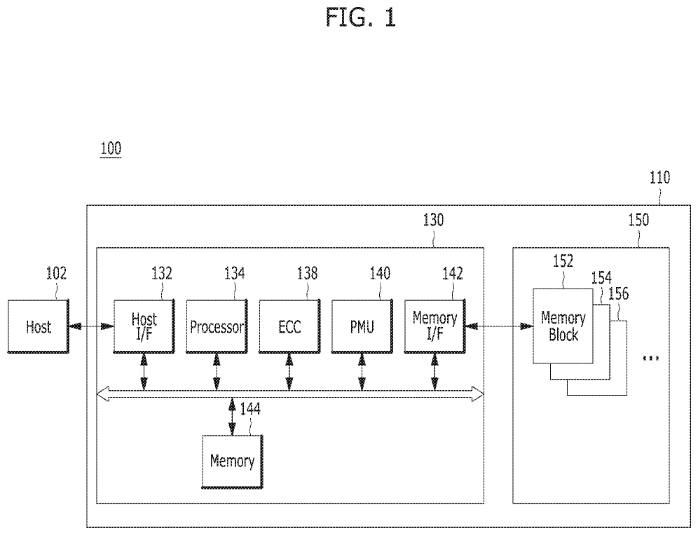

In FIG. 1, a data processing system 100 in accordance with an embodiment of the disclosure is described. Referring to FIG. 1, the data processing system 100 may include a host 102 engaged or operatively coupled with a memory system 110.

The host 102 may include, for example, a portable electronic device such as a mobile phone, an MP3 player and a laptop computer or an electronic device such as a desktop computer, a game player, a television (TV), a projector and the like.

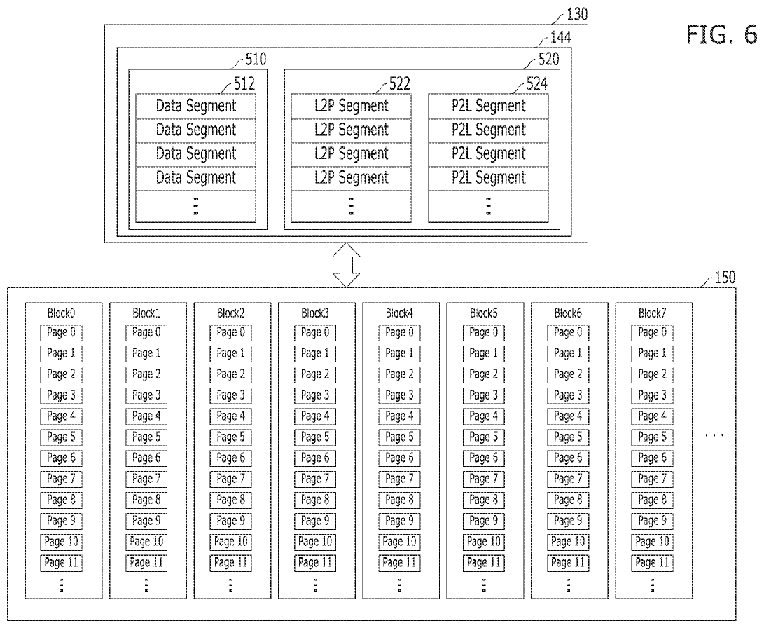

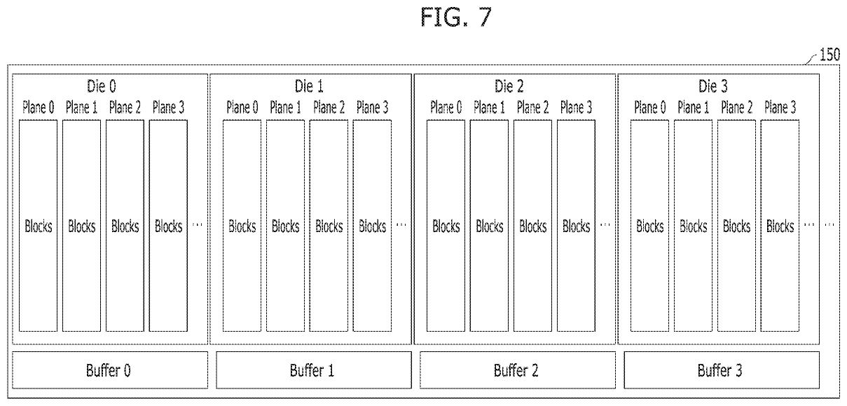

The host 102 also includes at least one operating system (OS), which can generally manage and control functions and operations performed in the host 102. The OS can provide interoperability between the host 102 engaged with the memory system 110 and the user needing and using the memory system 110. The OS may support functions and operations corresponding to user's requests. By the way of example but not limitation, the OS can be classified into a general operating system and a mobile operating system according to mobility of the host 102. The general operating system may be split into a personal operating system and an enterprise operating system according to system requirements or user's environment. The personal operating system, including Windows and Chrome, may be subject to support services for general purposes. But the enterprise operating systems can be specialized for securing and supporting high performance, including Windows servers, Linux, Unix and the like. Further, the mobile operating system may include an Android, an iOS, a Windows mobile and the like. The mobile operating system may be subject to support services or functions for mobility (e.g., a power saving function). The host 102 may include a plurality of operating systems. The host 102 may execute multiple operating systems interlocked with the memory system 110, corresponding to user's request. The host 102 may transmits a plurality of commands corresponding to user's requests into the memory system 110, thereby performing operations corresponding to commands within the memory system 110. Handling plural commands in the memory system 110 is described later, referring to FIGS. 6 and 7.

The memory system 110 may operate or perform a specific function or operation in response to a request from the host 102 and, particularly, may store data to be accessed by the host 102. The memory system 110 may be used as a main memory system or an auxiliary memory system of the host 102. The memory system 110 may be implemented with any one of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, a memory stick, and the like.

The storage devices for the memory system 110 may be implemented with a volatile memory device, for example, a dynamic random access memory (DRAM) and a static RAM (SRAM), and/or a nonvolatile memory device such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM or ReRAM) and a flash memory.

The memory system 110 may include a controller 130 and a memory device 150. The memory device 150 may store data to be accessed by the host 102. The controller 130 may control storage of data in the memory device 150.

The controller 130 and the memory device 150 may be integrated into a single semiconductor device, which may be included in the various types of memory systems as exemplified above.

By the way of example but not limitation, the controller 130 and the memory device 150 may be integrated into a single semiconductor device. Such integration may improve operation speed. When the memory system 110 is used as an SSD, the operating speed of the host 102 connected to the memory system 110 can be improved to a greater extent than that of the host 102 when the memory system 110 is implemented with a hard disk. In another embodiment, the controller 130 and the memory device 150 may be integrated into one semiconductor device to form a memory card, e.g., a PC card (PCMCIA), a compact flash (CF) card, a memory card such as a smart media card (SM, SMC), a memory stick, a multimedia card (MMC, RS-MMC, MMCmicro), a SD card (SD, miniSD, microSD, SDHC), a universal flash memory and the like.

The memory system 110 may be configured as a part of, for example, a computer, an ultra-mobile PC (UMPC), a workstation, a net-book, a personal digital assistant (PDA), a portable computer, a web tablet, a tablet computer, a wireless phone, a mobile phone, a smart phone, an e-book, a portable multimedia player (PMP), a portable game player, a navigation system, a black box, a digital camera, a digital multimedia broadcasting (DMB) player, a 3-dimensional (3D) television, a smart television, a digital audio recorder, a digital audio player, a digital picture recorder, a digital picture player, a digital video recorder, a digital video player, a storage configuring a data center, a device capable of transmitting and receiving information under a wireless environment, one of various electronic devices configuring a home network, one of various electronic devices configuring a computer network, one of various electronic devices configuring a telematics network, a radio frequency identification (RFID) device, or one of various components configuring a computing system.

The memory device 150 may be a nonvolatile memory device that retains data stored therein even while electrical power is not supplied. The memory device 150 may store data provided from the host 102 through a write operation, while providing data stored therein to the host 102 through a read operation. The memory device 150 may include a plurality of memory blocks 152, 154, 156, each of which may include a plurality of pages. Each of the plurality of pages may include a plurality of memory cells to which a plurality of word lines (WL) are electrically coupled. The memory device 150 also includes a plurality of memory dies, each of which includes a plurality of planes, each of which includes a plurality of memory blocks 152, 154, 156. In addition, the memory device 150 may be a non-volatile memory device, for example a flash memory, wherein the flash memory may be a three dimensional stack structure.

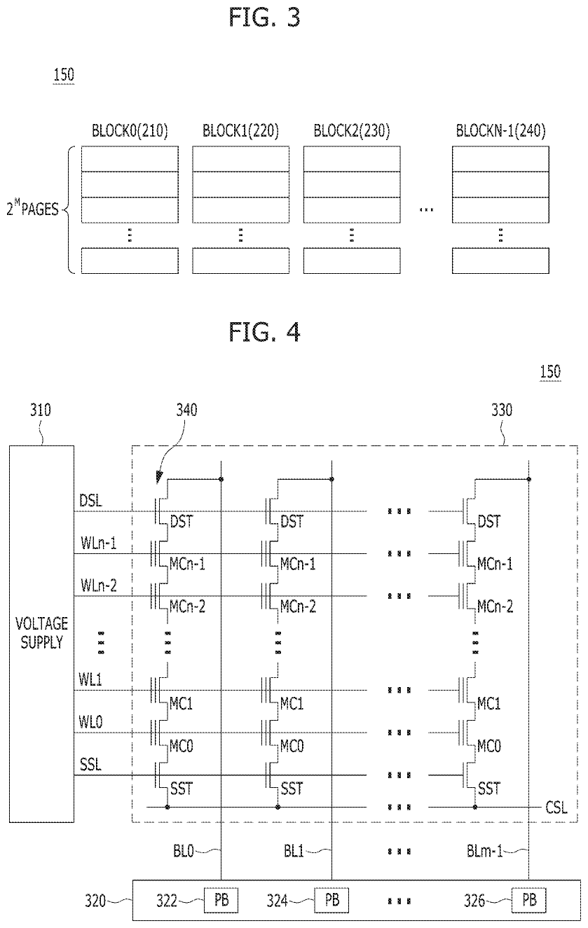

A structure of the memory device 150 and/or a three-dimensional solid stack structure of the memory device 150 will be described in more detail below with reference to FIGS. 3 to 5. The memory device 150 including a plurality of memory dies each including a plurality of planes each including the plurality of memory blocks 152, 154, 156 will be described in more detail in FIG. 7. Thus, detailed description thereof is omitted here.

The controller 130 may control overall operations of the memory device 150, such as read, write, program and erase operations. For example, the controller 130 may control the memory device 150 in response to a request from the host 102. The controller 130 may provide the data, read from the memory device 150, with the host 102. The controller 130 may store the data, provided by the host 102, into the memory device 150.

The controller 130 may include a host interface (I/F) 132, a processor 134, an error correction code (ECC) component 138, a power management unit (PMU) 140, a memory interface (I/F) 142 and a memory 144, all operatively coupled via an internal bus.

The host interface 132 may process commands and data provided from the host 102, and may communicate with the host 102 through at least one of various interface protocols such as universal serial bus (USB), multimedia card (MMC), peripheral component interconnect-express (PCI-e or PCIe), small computer system interface (SCSI), serial-attached SCSI (SAS), serial advanced technology attachment (SATA), parallel advanced technology attachment (PATA), enhanced small disk interface (ESDI) and integrated drive electronics (IDE). According to an embodiment, the host interface 132 is a component for exchanging data with the host 102, which may be implemented through firmware called a host interface layer (HIL).

The ECC component 138 may correct error bits of the data to be processed in (e.g., outputted from) the memory device 150, which may include an ECC encoder and an ECC decoder. Here, the ECC encoder can perform error correction encoding of data to be programmed in the memory device 150 to generate encoded data into which a parity bit is added and store the encoded data in memory device 150. The ECC decoder can detect and correct errors contained in a data read from the memory device 150 when the controller 130 reads the data stored in the memory device 150. In other words, after performing error correction decoding on the data read from the memory device 150, the ECC component 138 can determine whether the error correction decoding has succeeded and output an instruction signal (e.g., a correction success signal or a correction fail signal). The ECC component 138 can use the parity bit which is generated during the ECC encoding process, for correcting the error bit of the read data. When the number of the error bits is greater than or equal to a threshold number of correctable error bits, the ECC component 138 may not correct error bits but instead may output an error correction fail signal indicating failure in correcting the error bits.

The ECC component 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM), and on the like. The ECC component 138 may include suitable circuits, modules, systems and/or devices for performing the error correction operation based on at least one of the above described codes.

The PMU 140 may provide and manage an electrical power in the controller 130.

The memory interface 142 may serve as an interface for handling commands and data transferred between the controller 130 and the memory device 150, to allow the controller 130 to control the memory device 150 in response to a request delivered from the host 102. The memory interface 142 may generate a control signal for the memory device 150 and may process data entered into or outputted from the memory device 150 under the control of the processor 134 in a case when the memory device 150 is a flash memory and, in particular, when the memory device 150 is a NAND flash memory. The memory interface 142 can provide an interface for handling commands and data between the controller 130 and the memory device 150, for example, operations of NAND flash interface, in particular, operations between the controller 130 and the memory device 150. According to an embodiment, the memory interface 142 can be implemented through a firmware called a Flash Interface Layer (FIL) as a component for exchanging data with the memory device 150.

The memory 144 may support operations performed by the memory system 110 and the controller 130. The memory 144 may store temporary or transactional data occurred or delivered for operations in the memory system 110 and the controller 130. The controller 130 may control the memory device 150 in response to a request from the host 102. The controller 130 may deliver data read from the memory device 150 into the host 102. The controller 130 may store data entered through the host 102 within the memory device 150. The memory 144 may be used to store data required for the controller 130 and the memory device 150 to perform operations such as read operations or program/write operations.

The memory 144 may be implemented with a volatile memory. The memory 144 may be implemented with a static random access memory (SRAM), a dynamic random access memory (DRAM) or both. Although FIG. 1 shows the memory 144 disposed within the controller 130, the invention is not limited thereto. That is, the memory 144 may be located within or externally to the controller 130. For instance, the memory 144 may be embodied by an external volatile memory having a memory interface transferring data and/or signals between the memory 144 and the controller 130.

The memory 144 can store data necessary for performing operations such as data writing and data reading requested by the host 102 and/or data transfer between the memory device 150 and the controller 130 for background operations such as garbage collection, wear levelling as described above. According to an embodiment, for supporting operations in the memory system 110, the memory 144 may include a program memory, a data memory, a write buffer/cache, a read buffer/cache, a data buffer/cache, a map buffer/cache, and the like.

The processor 134 may be implemented with a microprocessor or a central processing unit (CPU). The memory system 110 may include one or more processors 134, which may control the overall operations of the memory system 110. By the way of example but not limitation, the processor 134 can control a program operation or a read operation of the memory device 150, in response to a write request or a read request entered from the host 102. According to an embodiment, the processor 134 may use or execute firmware to control the overall operations of the memory system 110. Herein, the firmware may be referred to as a flash translation layer (FTL). The FTL may perform an operation as an interface between the host 102 and the memory device 150. The host 102 may transmit requests for write and read operations to the memory device 150 through the FTL.

The FTL may manage operations of address mapping, garbage collection, wear-leveling and so forth. Particularly, the FTL may load, generate, update, or store map data. Therefore, the controller 130 may map a logical address, which is entered from the host 102, with a physical address of the memory device 150 through the map data. The memory device 150 may function as a general storage device to perform a read or write operation because of the address mapping operation. Also, through the address mapping operation based on the map data, when the controller 130 tries to update data stored in a particular page, the controller 130 may program the updated data on another empty page and may invalidate old data of the particular page (e.g., update a physical address, corresponding to a logical address of the updated data, from the previous particular page to the another newly programmed page) due to a characteristic of a flash memory device. Further, the controller 130 may store map data of the new data into the FTL.

For example, for performing an operation requested from the host 102 in the memory device 150, the controller 130 uses the processor 134 implemented as a microprocessor or a central processing unit (CPU) or the like. The processor 134 engaged with the memory device 150 can process internal instructions or commands corresponding to an inputted command from the host 102. The controller 130 can perform a foreground operation as a command operation, corresponding to an command inputted from the host 102, such as a program operation corresponding to a write command, a read operation corresponding to a read command, an erase/discard operation corresponding to an erase/discard command and a parameter set operation corresponding to a set parameter command or a set feature command (sometimes, along with a set command).

For another example, the controller 130 may perform a background operation on the memory device 150 through the processor 134. By the way of example but not limitation, the background operation for the memory device 150 includes an operation (e.g., a garbage collection (GC) operation) for copying data stored in one memory block among the memory blocks 152, 154, 156 in the memory device 150 and storing the copied data in another memory block. The background operation can include an operation (e.g., a wear leveling (WL) operation) to move or swap data between any two or more of the memory blocks 152, 154, 156 in memory device 150. As the background operation, the controller 130 uses the processor 134 for storing the map data stored in the controller 130 to at least one of the memory blocks 152, 154, 156 in the memory device 150, e.g., a map flush operation. A bad block management operation of checking for bad blocks among the plurality of memory blocks 152, 154, 156 is another example of a background operation performed by the processor 134.

In the memory system 110, the controller 130 performs a plurality of command operations corresponding to a plurality of commands entered from the host 102. For example, when performing a plurality of program operations corresponding to plural program commands, a plurality of read operations corresponding to plural read commands and a plurality of erase operations corresponding to plural erase commands sequentially, randomly or alternatively, the controller 130 can determine which channel(s) or way(s) among a plurality of channels (or ways) for connecting the controller 130 to a plurality of memory dies in the memory device 150 is/are proper or appropriate for performing each operation. The controller 130 can send or transmit data or instructions via determined channels or ways for performing each operation. The plurality of memory dies in the memory device 150 can transmit an operation result via the same channels or ways, respectively, after each operation is complete. Then, the controller 130 may transmit a response or an acknowledge signal to the host 102. In an embodiment, the controller 130 can check a status of each channel or each way. In response to a command entered from the host 102, the controller 130 may select at least one channel or way based on the status of each channel or each way so that instructions and/or operation results with data may be delivered via selected channel(s) or way(s).

By the way of example but not limitation, the controller 130 can recognize statuses regarding a plurality of channels (or ways) associated with a plurality of memory dies included in the memory device 150. The controller 130 may determine each channel or each way as one of a busy state, a ready state, an active state, an idle state, a normal state and/or an abnormal state. Controller's determination of which channel or way an instruction (and/or a data) is delivered through can be associated with a physical block address, e.g., which die(s) the instruction (and/or the data) is delivered into. The controller 130 can refer to descriptors delivered from the memory device 150. The descriptors can include a block or page of parameters that describe something about the memory device 150, which is a data with a predetermined format or structure. For instance, the descriptors may include device descriptors, configuration descriptors, unit descriptors, and the like. The controller 130 can refer to, or use, the descriptors to determine which channel(s) or way(s) an instruction or a data is exchanged via.

A management unit (not shown) may be included in the processor 134. The management unit may perform bad block management of the memory device 150. The management unit may find bad memory blocks included in the memory device 150, which are in unsatisfactory condition for further use, as well as perform bad block management on the bad memory blocks. When the memory device 150 is a flash memory, for example, a NAND flash memory, a program failure may occur during the write operation, for example, during the program operation, due to characteristics of a NAND logic function. During the bad block management, the data of the program-failed memory block or the bad memory block may be programmed into a new memory block. The bad blocks may seriously aggravate the utilization efficiency of the memory device 150 having a 3D stack structure and the reliability of the memory system 110. Thus, reliable bad block management may enhance or improve performance of the memory system 110.

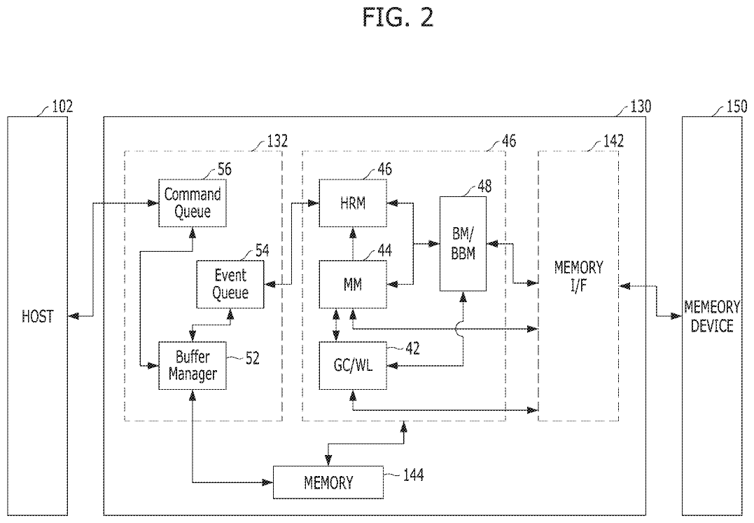

Referring to FIG. 2, the controller 130 in the memory system 110 in accordance with another example of the disclosure is described in detail. The controller 130 operates along with the host 102 and the memory device 150. The controller 130 can include the host interface 132, a flash translation layer (FTL) 40, the memory interface 142 and the memory 144.

Although not shown in FIG. 2, the ECC component 138 described in FIG. 1 may be included in the flash translation layer (FTL) 40. In another embodiment, the ECC component 138 may be implemented as a separate module, a circuit, a firmware or the like, which is included in, or associated with, the controller 130.

The host interface 132 is for handling commands, data, and the like transmitted from the host 102. By way of example but not limitation, the host interface 132 can include a command queue 56, a buffer manager 52 and an event queue 54. The command queue 56 can sequentially store commands, data, and the like transmitted from the host 102 and output them to the buffer manager 52 in a stored order or a first-in-first-out (FIFO) scheme. The buffer manager 52 can classify, manage or adjust the commands, the data, and the like, which are delivered from the command queue 56. The event queue 54 can sequentially transmit events for processing the commands, the data, and the like transmitted from the buffer manager 52.

A plurality of commands or data of the same characteristic may be continuously transmitted from the host 102, or commands and data of different characteristics may be randomly transmitted to the memory system 110. For example, a plurality of read commands may be delivered, or read and write commands may be alternately transmitted to the memory system 110. The host interface 132 can store commands, data, and the like, which are transmitted from the host 102, to the command queue 56 sequentially. Thereafter, the host interface 132 can estimate or predict, according to the characteristics of the command, data, etc., which is transmitted from the host 102, what kind of operation the controller 130 will perform. The host interface 132 can determine a processing order and a priority of commands, data and the like, based at least on their characteristics. According to characteristics of commands, data, and the like transmitted from the host 102, the buffer manager 52 in the host interface 132 is configured to determine whether to store commands, data, and the like in the memory 144, or whether to deliver the commands, the data, and the like into the flash translation layer (FTL) 40. The event queue 54 receives events, entered from the buffer manager 52, which are to be internally executed and processed by the memory system 110 or the controller 130 in response to the commands, the data, etc. transmitted from the host 102, so as to deliver the events into the flash translation layer (FTL) 40 in the order received.

According to an embodiment, the flash translation layer (FTL) 40 can include a host request manager (HRM) 46, a map manager (MM) 44, a state manager (GC/WL) 42 and a block manager (BM/BBM) 48. The host request manager (HRM) 46 can manage the events entered from the event queue 54. The map manager (MM) 44 can handle or control a map data. The state manager 42 can perform garbage collection or wear leveling. The block manager 48 can execute commands or instructions onto a block in the memory device 150.

By the way of example but not limitation, the host request manager (HRM) 46 can control the map manager (MM) 44 and the block manager 48 to handle or process requests according to the read and program commands and events which are delivered from the host interface 132. The host request manager (HRM) 46 can send an inquiry to the map manager (MM) 44, to identify a physical address corresponding to the logical address which is entered with the events. The host request manager (HRM) 46 can send a read request with the physical address to the memory interface 142, to process the read request (handle the events). On the other hand, the host request manager (HRM) 46 can sends a program request (write request) to the block manager 48, to program entered data to a specific page of the unrecorded (no data) in the memory device 150, and then, can transmit a map update request corresponding to the program request to the map manager (MM) 44, to update an item relevant to the programmed data in information of mapping the logical-physical addresses to each other.

Here, the block manager 48 can convert a program request delivered from the host request manager (HRM) 46, the map manager (MM) 44, and/or the state manager 42 into a flash program request used for the memory device 150, to manage flash blocks in the memory device 150. In order to maximize or enhance program or write performance of the memory system 110, the block manager 48 may collect program requests and send flash program requests for multiple-plane and one-shot program operations to the memory interface 142. The block manager 48 may send several flash program requests to the memory interface 142 to enhance or maximize parallel processing of the multi-channel and multi-directional flash controller 130.

On the other hand, the block manager 48 can be configured to manage blocks in the memory device 150 according to the number of valid pages, select and erase blocks having no valid pages when a free block is needed, and select a block including the least valid page when it is determined that garbage collection is necessary. The state manager 42 can perform garbage collection to move the valid data to an empty block and erase the blocks containing the moved valid data so that the block manager 48 may determine that there are enough free blocks (empty blocks with no data) in the memory device 150. If the block manager 48 provides information regarding a block to be erased to the state manager 42, the state manager 42 could check all flash pages of the block to be erased to determine whether each page is valid. For example, to determine validity of each page, the state manager 42 can identify a logical address recorded in an out-of-band (OOB) area of each page. To determine whether each page is valid, the state manager 42 can compare the physical address of the page with the physical address mapped to the logical address obtained for the inquiry request. The state manager 42 sends a program request to the block manager 48 for each valid page. A mapping table can be updated by the map data manager 44 when the program operation is complete.

The map data manager 44 can manage a logical-physical mapping table. The map data manager 44 can process requests such as queries, updates, and the like, which are generated by the host request manager (HRM) 46 or the state manager 42. The map data manager 44 may store the entire mapping table in the memory device 150 (e.g., a flash/non-volatile memory) and cache mapping entries according to the storage capacity of the memory 144. When a map cache miss occurs while processing inquiry or update requests, the map data manager 44 may send a read request to the memory interface 142 to load a relevant mapping table stored in the memory device 150. When the number of dirty cache blocks in the map data manager 44 exceeds a certain threshold, a program request can be sent to the block manager 48 so that a clean cache block is made as well as the dirty map table may be stored in the memory device 150.

On the other hand, when garbage collection is performed, the state manager 42 copies valid page(s) into a free block, and the host request manager (HRM) 46 can program the latest version of the data for the same logical address of the page and currently issue an update request. When the status manager 42 requests the map update in a state in which copying of valid page(s) is not completed successfully, the map data manager 44 may not perform the mapping table update. It is because the map request is issued with old physical information if the status manger 42 requests a map update and a valid page copy is completed later. The map data manager 44 may perform a map update operation to ensure accuracy only if the latest map table still points to the old physical address.

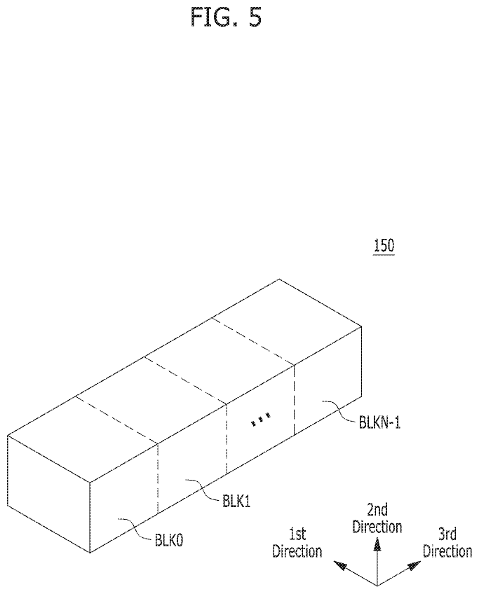

FIG. 3 shows an example of a memory device included in a memory system according to an embodiment of the invention, FIG. 4 shows a non-volatile memory cell array in memory blocks included in a memory device according to an embodiment of the invention, and FIG. 5 shows an example of a 3-dimensional memory device structure in a memory system according to an embodiment of the invention.

Referring to FIG. 3, the memory device 150 can include a plurality of memory blocks, such as a first block (BLOCK0) 210, a second block (BLOCK1) 220, a third block (BLOCK2) 230, and a n^{th} block (BLOCKN−1) 240. Each of blocks 210, 220, 230, 240 can include a plurality of pages, e.g., 2^{M} pages, 2M Pages, or M pages. Here, n and M are natural numbers. For convenience of explanation, it is assumed that each of memory blocks includes 2M pages. Each of the pages can include a plurality of non-volatile memory cells coupled via at least one word line (WL) with each other.

The memory device 150 can include a plurality of memory blocks. Each of the plurality of memory blocks is one of different types of memory blocks such as a single level cell (SLC) memory block, a multi-level cell (MLC) memory block or the like, according to the number of bits that can be stored or represented in one memory cell. Here, the SLC memory block includes a plurality of pages implemented by memory cells, each storing one bit of data. The SLC memory block can have high data I/O operation performance and high durability. The MLC memory block includes a plurality of pages implemented by memory cells, each storing multi-bit data (e.g., two bits or more). The MLC memory block can have larger storage capacity than the SLC memory block. The MLC memory block can be highly integrated to provide larger storage capacity within the same amount of space as the SLC memory block. In an embodiment, the memory device 150 may be implemented with MLC memory blocks such as an MLC′ memory block, a triple level cell (TLC) memory block, a quadruple level cell (QLC) memory block and a combination thereof. The MLC′ memory block may include a plurality of pages implemented by memory cells, each capable of storing 2-bit data. The triple level cell (TLC) memory block can include a plurality of pages implemented by memory cells, each capable of storing 3-bit data. The quadruple level cell (QLC) memory block can include a plurality of pages implemented by memory cells, each capable of storing 4-bit data. In another embodiment, the memory device 150 can be implemented with a block including a plurality of pages implemented by memory cells, each capable of storing 5-bit or more bit data.

In an embodiment of the disclosure, the memory device 150 is embodied as a nonvolatile memory such as a flash memory, e.g., a NAND flash memory, a NOR flash memory and the like. In other embodiments, the memory device 150 may be implemented by at least one of a phase change random access memory (PCRAM), a ferroelectrics random access memory (FRAM), a spin torque transfer magnetic random access memory (STT-RAM), and a spin transfer torque magnetic random access memory (STT-MRAM), or the like.

Each of the blocks 210, 220, 230, 240 in the memory device 150 can store data provided from the host 102 through a program operation and provide the stored data to the host 102 through a read operation.

Referring to FIG. 4, a memory block 330 which may correspond to any of the plurality of memory blocks 152, 154, 156 included in the memory device 150 of the memory system 110 may include a plurality of cell strings 340 coupled to a plurality of corresponding bit lines BL0 to BLm−1. The cell string 340 of each column may include one or more drain select transistors DST and one or more source select transistors SST. Between the drain and source select transistors DST, SST, a plurality of memory cells or memory cell transistors MC0 to MCn−1 may be coupled in series. In an embodiment, each of the memory cell transistors MC0 to MCn−1 may be embodied by an MLC capable of storing data information of a plurality of bits. Each of the cell strings 340 may be electrically coupled to a corresponding bit line among the plurality of bit lines BL0 to BLm−1. For example, as illustrated in FIG. 3, the first cell string is coupled to the first bit line BL0, and the last cell string is coupled to the last bit line BLm−1.

Although FIG. 4 illustrates NAND flash memory cells, the invention is not limited in this way. It is noted that the memory cells may be NOR flash memory cells, or hybrid flash memory cells including two or more kinds of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply 310 which provides word line voltages including a program voltage, a read voltage and a pass voltage to supply to the word lines according to an operation mode. The voltage generation operation of the voltage supply 310 may be controlled by a control circuit (not illustrated). Under the control of the control circuit, the voltage supply 310 may select one of the memory blocks (or sectors) of the memory cell array, select one of the word lines of the selected memory block, and provide the word line voltages to the selected word line and the unselected word lines as may be needed.

The memory device 150 may include a read/write circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and may supply a current or a voltage onto bit lines according to the received data. The read/write circuit 320 may include a plurality of page buffers 322, 324, 326 respectively corresponding to columns (or bit lines) or column pairs (or bit line pairs). Each of the page buffers 322, 324, 326 may include a plurality of latches (not illustrated).

In addition, the memory device 150 may be implemented as a two-dimensional or three-dimensional memory device, and may be implemented as a non-volatile memory device of a three-dimensional solid stack structure. The memory device 150 may include a plurality of memory blocks BLK0 to BLKN−1. FIG. 5 is a block diagram for showing the memory blocks 152, 154, 156 of the memory device 150 shown in FIG. 1. Each of the memory blocks 152, 154, 156 can be implemented as a three-dimensional structure. For example, each of the memory blocks 152, 154, 156 may be realized by a structure with dimensions extending in mutually orthogonal directions, e.g., an x-axis direction, a y-axis direction, and a z-axis direction.

By the way of example but not limitation, each memory block 330 included in the memory device 150 may include a plurality of NAND strings (NSs) extending along a second direction, and/or can be provided with a plurality of NAND strings (NSs) along with a first direction or a third direction. Here, each NAND string NS is coupled with I/O control circuits via at least one of a bit line BL, at least one source select line SSL, at least one drain select line DSL, a plurality of word lines WL, at least one dummy word Line DWL and a common source line CSL. The NAND string (NS) may include a plurality of transistors for switching on plural lines.

Each of the plurality of memory blocks 152, 154, 156 in the memory device 150 can include a plurality of bit lines BL, a plurality of source select lines SSL, a plurality of drain select lines DSL, a plurality of word lines WL, a plurality of dummy word lines DWL and a plurality of common source lines CSL. Each memory block 330 includes a plurality of NAND strings (NSs) shown in FIG. 4.

Referring to FIGS. 6 to 12, data processing to a memory device in a memory system according to embodiments of the invention will be described in more detail. Particularly, a plurality of operations corresponding to commands entered from the host 102 are performed. The case of performing the operations will be described in more detail.

FIGS. 6 to 7 schematically illustrate an example of performing a plurality of command operations corresponding to a plurality of commands in the memory system according to an embodiment of the disclosure. This is described in different contexts of a data processing operation, a first of which is a case where a plurality of write commands are received from the host 102 and program operations corresponding to the write commands are performed, a second of which is a case where a plurality of read commands are received from the host 102 and read operations corresponding to the read commands are performed, a third of which is a case where a plurality of erase commands are received from the host 102 and erase operations corresponding to the erase commands are performed, and a fourth of which is a case where a plurality of write commands and a plurality of read commands are received together from the host 102 and program operations and read operations corresponding to the write commands and the read commands are performed.

Moreover, in an embodiment of the disclosure, a case is described in which write data corresponding to a plurality of write commands entered from the host 102 are stored in the buffer/cache included in the memory 144 of the controller 130, the write data stored in the buffer/cache are programmed to and stored in the plurality of memory blocks included in the memory device 150, map data are updated in correspondence to the stored write data in the plurality of memory blocks, and the updated map data are stored in the plurality of memory blocks included in the memory device 150. In other words, a case is described in which program operations corresponding to a plurality of write commands entered from the host 102 are performed. Furthermore, in still another embodiment of the disclosure, a case is described in which a plurality of read commands are entered from the host 102 for the data stored in the memory device 150, data corresponding to the read commands are read from the memory device 150 by checking the map data of the data corresponding to the read commands, the read data are stored in the buffer/cache included in the memory 144 of the controller 130, and the data stored in the buffer/cache are provided to the host 102. In other words, a case where read operations corresponding to a plurality of read commands entered from the host 102 are performed is described. In addition, in another embodiment of the disclosure, a case is described in which a plurality of erase commands are received from the host 102 for the memory blocks included in the memory device 150, memory blocks are checked corresponding to the erase commands, the data stored in the checked memory blocks are erased, map data are updated in correspondence to the erased data, and the updated map data are stored in the plurality of memory blocks included in the memory device 150. Namely, a case where erase operations corresponding to a plurality of erase commands received from the host 102 are performed is described.

In connection with such description it is described as an example that the controller 130 performs command operations in the memory system 110. However, it is noted that, as described above, the processor 134 in the controller 130 may perform command operations in the memory system 110, through, for example, an FTL (flash translation layer). Also, the controller 130 programs and stores user data and metadata corresponding to write commands entered from the host 102, in arbitrary memory blocks among the plurality of memory blocks included in the memory device 150, reads user data and metadata corresponding to read commands received from the host 102, from arbitrary memory blocks among the plurality of memory blocks included in the memory device 150, and provides the read data to the host 102, or erases user data and metadata, corresponding to erase commands entered from the host 102, from arbitrary memory blocks among the plurality of memory blocks in the memory device 150.

Metadata may include first map data including a logical/physical (L2P: logical to physical) information (logical information) and second map data including a physical/logical (P2L: physical to logical) information (physical information), for data stored in memory blocks in correspondence to a program operation. Also, the metadata may include an information on command data corresponding to a command received from the host 102, an information on a command operation corresponding to the command, an information on the memory blocks of the memory device 150 for which the command operation is to be performed, and an information on map data corresponding to the command operation. In other words, metadata may include all remaining information and data excluding user data corresponding to a command received from the host 102.

That is to say, in an embodiment of the disclosure, in the case where the controller 130 receives a plurality of write commands from the host 102, program operations corresponding to the write commands are performed, and user data corresponding to the write commands are written and stored in empty memory blocks, open memory blocks or free memory blocks for which an erase operation has been performed, among the memory blocks of the memory device 150. Also, first map data, including an L2P map table or an L2P map list in which logical information as the mapping information between logical addresses and physical addresses for the user data stored in the memory blocks are recorded, and second map data, including a P2L map table or a P2L map list in which physical information as the mapping information between physical addresses and logical addresses for the memory blocks stored with the user data are recorded, are written and stored in empty memory blocks, open memory blocks or free memory blocks among the memory blocks of the memory device 150.

Here, in the case where write commands are entered from the host 102, the controller 130 writes and stores user data corresponding to the write commands in memory blocks. The controller 130 stores, in other memory blocks, metadata including first map data and second map data for the user data stored in the memory blocks. Particularly, in correspondence to that the data segments of the user data are stored in the memory blocks of the memory device 150, the controller 130 generates and updates the L2P segments of first map data and the P2L segments of second map data as the map segments of map data among the meta segments of metadata. The controller 130 stores them in the memory blocks of the memory device 150. The map segments stored in the memory blocks of the memory device 150 are loaded in the memory 144 included in the controller 130 and are then updated.

Further, in the case where a plurality of read commands are received from the host 102, the controller 130 reads read data corresponding to the read commands, from the memory device 150, stores the read data in the buffers/caches included in the memory 144 of the controller 130. The controller 130 provides the data stored in the buffers/caches, to the host 102, by which read operations corresponding to the plurality of read commands are performed.

In addition, in the case where a plurality of erase commands are received from the host 102, the controller 130 checks memory blocks of the memory device 150 corresponding to the erase commands, and then, performs erase operations for the memory blocks.

When command operations corresponding to the plurality of commands received from the host 102 are performed while a background operation is performed, the controller 130 loads and stores data corresponding to the background operation, that is, metadata and user data, in the buffer/cache included in the memory 144 of the controller 130, and then stores the data, that is, the metadata and the user data, in the memory device 150. By the way of example but not limitation, the background operation may include a garbage collection operation or a read reclaim operation as a copy operation, a wear leveling operation as a swap operation or a map flush operation, For instance, for the background operation, the controller 130 may check metadata and user data corresponding to the background operation, in the memory blocks of the memory device 150, load and store the metadata and user data stored in certain memory blocks of the memory device 150, in the buffer/cache included in the memory 144 of the controller 130, and then store the metadata and user data, in certain other memory blocks of the memory device 150.

In the memory system in accordance with an embodiment of the disclosure, in the case of performing command operations as foreground operations and a copy operation, a swap operation and a map flush operation as background operations, the controller 130 schedules queues corresponding to the foreground operations and the background operations and allocates the scheduled queues to the memory 144 included in the controller 130 and the memory included in the host 102. In this regard, the controller 130 assigns identifiers (IDs) by respective operations for the foreground operations and the background operations to be performed in the memory device 150, and schedules queues corresponding to the operations assigned with the identifiers, respectively. In the memory system in accordance with an embodiment of the disclosure, identifiers are assigned not only by respective operations for the memory device 150 but also by functions for the memory device 150, and queues corresponding to the functions assigned with respective identifiers are scheduled.

In the memory system in accordance with an embodiment of the disclosure, the controller 130 manages the queues scheduled by the identifiers of respective functions and operations to be performed in the memory device 150. The controller 130 manages the queues scheduled by the identifiers of a foreground operation and a background operation to be performed in the memory device 150. In the memory system in accordance with an embodiment of the disclosure, after memory regions corresponding to the queues scheduled by identifiers are allocated to the memory 144 included in the controller 130 and the memory included in the host 102, the controller 130 manages addresses for the allocated memory regions. The controller 130 performs not only the foreground operation and the background operation but also respective functions and operations in the memory device 150, by using the scheduled queues.

Referring to FIG. 6, the controller 130 performs command operations corresponding to a plurality of commands entered from the host 102, for example, program operations corresponding to a plurality of write commands entered from the host 102. The controller 130 programs and stores user data corresponding to the write commands, in memory blocks of the memory device 150. Also, in correspondence to the program operations with respect to the memory blocks, the controller 130 generates and updates metadata for the user data and stores the metadata in the memory blocks of the memory device 150.

The controller 130 generates and updates first map data and second map data which include information indicating that the user data are stored in pages included in the memory blocks of the memory device 150. That is to say, the controller 130 generates and updates L2P segments as the logical segments of the first map data and P2L segments as the physical segments of the second map data, and then stores them in pages included in the memory blocks of the memory device 150.

For example, the controller 130 caches and buffers the user data corresponding to the write commands entered from the host 102, in a first buffer 510 included in the memory 144 of the controller 130. Particularly, after storing data segments 512 of the user data in the first buffer 510 worked as a data buffer/cache, the controller 130 stores the data segments 512 stored in the first buffer 510 in pages included in the memory blocks of the memory device 150. As the data segments 512 of the user data corresponding to the write commands received from the host 102 are programmed to and stored in the pages included in the memory blocks of the memory device 150, the controller 130 generates and updates the first map data and the second map data. The controller 130 stores them in a second buffer 520 included in the memory 144 of the controller 130. Particularly, the controller 130 stores L2P segments 522 of the first map data and P2L segments 524 of the second map data for the user data, in the second buffer 520 as a map buffer/cache. As described above, the L2P segments 522 of the first map data and the P2L segments 524 of the second map data may be stored in the second buffer 520 of the memory 144 in the controller 130. A map list for the L2P segments 522 of the first map data and another map list for the P2L segments 524 of the second map data may be stored in the second buffer 520. The controller 130 stores the L2P segments 522 of the first map data and the P2L segments 524 of the second map data, which are stored in the second buffer 520, in pages included in the memory blocks of the memory device 150.

Also, the controller 130 performs command operations corresponding to a plurality of commands received from the host 102, for example, read operations corresponding to a plurality of read commands received from the host 102. Particularly, the controller 130 loads L2P segments 522 of first map data and P2L segments 524 of second map data as the map segments of user data corresponding to the read commands, in the second buffer 520, and checks the L2P segments 522 and the P2L segments 524. Then, the controller 130 reads the user data stored in pages of corresponding memory blocks among the memory blocks of the memory device 150, stores data segments 512 of the read user data in the first buffer 510, and then provides the data segments 512 to the host 102.

Furthermore, the controller 130 performs command operations corresponding to a plurality of commands entered from the host 102, for example, erase operations corresponding to a plurality of erase commands entered from the host 102. In particular, the controller 130 checks memory blocks corresponding to the erase commands among the memory blocks of the memory device 150 to carry out the erase operations for the checked memory blocks.

In the case of performing an operation of copying data or swapping data among the memory blocks included in the memory device 150, for example, a garbage collection operation, a read reclaim operation or a wear leveling operation, as a background operation, the controller 130 stores data segments 512 of corresponding user data, in the first buffer 510, loads map segments 522, 524 of map data corresponding to the user data, in the second buffer 520, and then performs the garbage collection operation, the read reclaim operation or the wear leveling operation. In the case of performing a map update operation and a map flush operation for metadata, e.g., map data, for the memory blocks of the memory device 150 as a background operation, the controller 130 loads the corresponding map segments 522, 524 in the second buffer 520, and then performs the map update operation and the map flush operation.

As aforementioned, in the case of performing functions and operations including a foreground operation and a background operation for the memory device 150, the controller 130 assigns identifiers by the functions and operations to be performed for the memory device 150. The controller 130 schedules queues respectively corresponding to the functions and operations assigned with the identifiers, respectively. The controller 130 allocates memory regions corresponding to the respective queues, to the memory 144 included in the controller 130 and the memory included in the host 102. The controller 130 manages the identifiers assigned to the respective functions and operations, the queues scheduled for the respective identifiers and the memory regions allocated to the memory 144 of the controller 130 and the memory of the host 102 in correspondence to the queues, respectively. The controller 130 performs the functions and operations for the memory device 150, through the memory regions allocated to the memory 144 of the controller 130 and the memory of the host 102.

Referring to FIG. 7, the memory device 150 includes a plurality of memory dies, for example, a memory die 0, a memory die 1, a memory die 2 and a memory die 3, and each of the memory dies includes a plurality of planes, for example, a plane 0, a plane 1, a plane 2 and a plane 3. The respective planes in the memory dies included in the memory device 150 include a plurality of memory blocks, for example, N number of blocks Block0, Block1, . . . , BlockN−1 each including a plurality of pages, for example, 2^{M} number of pages, as described above with reference to FIG. 3. Moreover, the memory device 150 includes a plurality of buffers corresponding to the respective memory dies, for example, a buffer 0 corresponding to the memory die 0, a buffer 1 corresponding to the memory die 1, a buffer 2 corresponding to the memory die 2 and a buffer 3 corresponding to the memory die 3.

In the case of performing command operations corresponding to a plurality of commands received from the host 102, data corresponding to the command operations are stored in the buffers included in the memory device 150. For example, in the case of performing program operations, data corresponding to the program operations are stored in the buffers, and are then stored in the pages included in the memory blocks of the memory dies. In the case of performing read operations, data corresponding to the read operations are read from the pages included in the memory blocks of the memory dies, are stored in the buffers, and are then provided to the host 102 through the controller 130.

In an embodiment of the disclosure, while it will be described below as an example that the buffers in the memory device 150 exist outside the respective corresponding memory dies, it is to be noted that the buffers may exist inside the respective corresponding memory dies, and it is to be noted that the buffers may correspond to the respective planes or the respective memory blocks in the respective memory dies. Further, while it will be described below as an example that the buffers in the memory device 150 are the plurality of page buffers 322, 324 and 326 as described above with reference to FIG. 4, it is to be noted that the buffers may be a plurality of caches or a plurality of registers included in the memory device 150.

Also, the plurality of memory blocks included in the memory device 150 may be grouped into a plurality of super memory blocks, and command operations may be performed in the plurality of super memory blocks. Each of the super memory blocks may include a plurality of memory blocks, for example, memory blocks included in a first memory block group and a second memory block group. In this regard, in the case where the first memory block group is included in the first plane of a certain first memory die, the second memory block group may be included in the first plane of the first memory die, be included in the second plane of the first memory die or be included in the planes of a second memory die.

In an embodiment of the disclosure, a data processing system may include plural memory systems. Each of the plural memory systems 110 can include the controller 130 and the memory device 150. In the data processing system, one of the plural memory systems 110 can be a master memory system and the others can be a slave memory system. The master memory system may be determined based on contention between the plural memory systems 110. When a plurality of commands is delivered from the host 102 in the data processing system, the master memory system can determine a destination of each command based at least on statuses of channels or buses. For example, a first memory system can be determined as a master memory system among a plurality of memory systems, corresponding to information delivered from the plurality of memory systems. If the first memory system is determined as the master memory system, the remaining memory systems are considered slave memory systems. A controller of the master memory system can check statuses of a plurality of channels (or ways, buses) coupled to a plurality of memory systems, to select which memory system handles commands or data delivered from the host 102. In an embodiment, a master memory system can be dynamically determined among the plural memory systems. In another embodiment, a master memory system may be changed with one of other slave memory systems periodically or according to an event.

A method and apparatus for transferring data in the memory system 110 including the memory device 150 and the controller 130 is described below in more detail. As the amount of data stored in the memory system 110 becomes larger, and the memory system 110 may be required to read or store large amounts of data at a time. However, a read time for reading a data stored in the memory device 150 or a program/write time for writing a data in the memory device 150 may be generally longer than a handling time for the controller 130 to process a data or a data transmission time between the controller 130 and the memory system 150. For example, the read time might be twice of the handling time. Since the read time or the program time is relatively far longer than the handling time or the data transmission time, a procedure or a process for delivering data in the memory system 110 may affect performance of the memory system 110, e.g., an operation speed, and/or structure of the memory system 110 such as a buffer size.

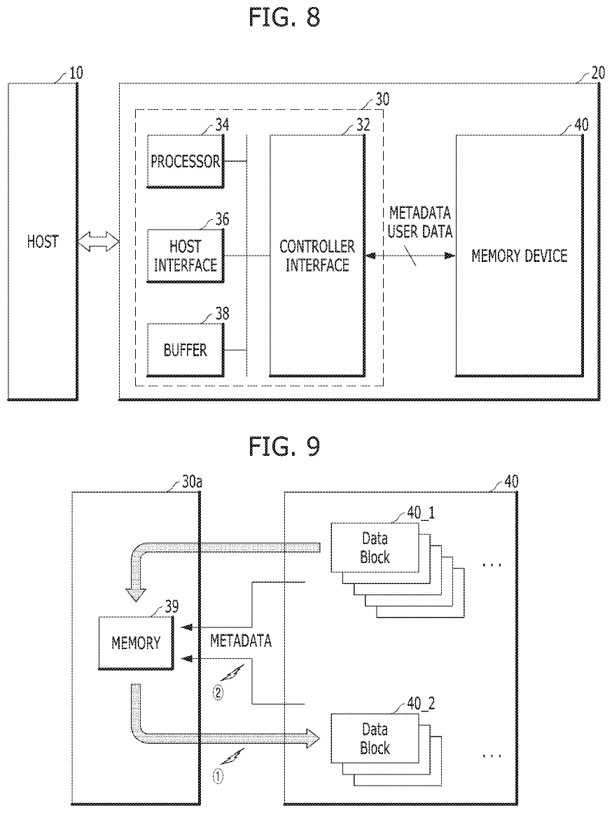

FIG. 8 describes a memory system 20 according to another embodiment of the disclosure. For example, in a computing device, a mobile or the like embedded with the memory system 20, a host 10 can be engaged with the memory system 20 for data input/output (I/O) operation.

Referring to FIG. 8, the memory system 20 can include a controller 30 and a memory device 40. The controller 30 may output a data, which is requested by the host 10 and delivered from the memory device 40, or store a data transferred from the host 10 in the memory device 40. The memory device 40 includes a plurality of non-volatile memory cells, each capable of storing data. Here, an internal structure and/or configuration of the memory device 40 can be different based on specification or required performance of the memory device 40. The specification or required performance is varied by purposes for which the memory system 20 is used or by requirements of the host 10. By way of example but not limitation, both the memory device 150 illustrated in FIGS. 1 through 7 and the memory device 40 shown in FIG. 8 may include substantially identical components. In addition, the controller 130 described in FIGS. 1 and 2 and the controller 30 described in FIG. 8 may also include substantially same elements.

The controller 30 may include at least one processor 34, a host interface 36, a buffer 38, and a controller interface 32. The processor 34 is for handling an operation or a process generated by an internal/external command within the controller 30, which can play a role like that of a CPU included in a computer. The host interface 36 can be for supporting communication between the memory system 20 and the host 10, and the controller interface 32 can support communication between the memory device 40 and the controller 30. The buffer 38 can temporarily store derived or generated data and/or operational status during the operation of the processor 34, the host interface 36 and the controller interface 32. The buffer 38 may support a data transmission between the memory device 40 and the host 10.

According to embodiments, the internal structure or configuration of the controller 30 may be constituted with at least one circuitry corresponding to each element such as at least one processor 34, a host interface 36, a buffer 38 and a controller interface 32. As used in this application, the term ‘circuitry’ refers to any and all of the following: (a) hardware-only circuit implementations such as implementations in only analog and/or digital circuitry and (b) combinations of circuits and software and/or firmware, such as (as applicable): (i) a combination of processor(s) or (ii) portions of processor(s)/software including digital signal processor(s), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, the term “circuitry” also covers an implementation of merely one or more processors or portion thereof and its (or their) accompanying software and/or firmware. The term “circuitry” also covers, for example and if applicable to the particular claim element, an integrated circuit or applications processor integrated circuit for a controller, a computing device, a gaming device, a mobile phone, a display, or a network or communication device. According to another embodiment, the internal structure or configuration of the controller 30 may include elements based on functional classification according to an operation, a task, and the like which is processed by the controller 30.

According to an embodiment, the controller 30 can include physical components including at least one processor, at least one memory, at least one input/output port, a wire for electrically coupling one with another, and the like.

The controller 30 and the memory device 40 can exchange metadata and user data. Herein, the user data can include various data to be inputted and stored by the user through the host 10, and the metadata can include system information (for example, map data and the like) used for storing the user data in the memory device 40. The user data and the meta data can be processed or managed in different ways in the controller 30 since characteristics or properties thereof are different from each other.

Even with increased storage capacity of the memory device 40, it is difficult for the controller 30 to store all of status information including system information, map information, operational state information and the like, which are used, or referred to, for operations such as a read operation, a program operation and an erase operation performed with a plurality of dies, a plurality of blocks, or a plurality of pages included in the memory device 40. As the storage capacity increases, the amount of status information may increase as well. It might be difficult to include within the controller 30 additional memory having an enough storage capacity for all of status information. Accordingly, the memory device 40 can be used to store the user data as well as various status information including the system information, the map information, the operational state information, and the like for operations such as a read operation, a program operation and an erase operation. The controller 30 may load some or partial status information stored in the memory device 40 for operations such as a read operation, a program operation and an erase operation performed with a plurality of dies, a plurality of blocks, or a plurality of pages. After completing the operations, the controller 30 can store updated and loaded status information in the memory device 40.

Although not shown, as the number of cells capable of storing data in the memory device 40 increases, an internal configuration or structure of the memory device 40 may become more complicated as described in FIG. 7. The controller 30 may transmit to, or receive from, the memory device 40 data with connection information according to the internal configuration or structure of the memory device 40. For example, when a plurality of dies is included in the memory device 40, the controller 30 can exchange data through n channels and m ways with the memory device 40. However, in order for the controller 30 to read or write data from or to the memory device 40, additional control variables or control signals may be required depending on the internal configuration or structure of the memory device 40.

The memory device 40 can include a plurality of blocks capable of storing data. The controller 30 engaged with the memory device 40 may store or program voluminous data in the memory device 40. Herein, the voluminous data may have sizes that require at least two blocks among the plural blocks in the memory device 40. The controller 30 can record operation information used for determining into which blocks the voluminous data are to be programmed. The operation information may include a reference regarding how to determine a hopping sequence of the at least two blocks (e.g., hopping rules). When power is supplied after the program operation is undesirably halted, the controller 30 can resume the program operation based on the operation information. The controller 30 may scan a specific block indicated by the operation information, instead of scanning an entire metadata area of the memory device 40 to find the specific block for resuming the program operation that was undesirably halted.

FIG. 9 illustrates movement of large amounts of data for wear leveling.

Wear leveling is a technique for extending the life or improving durability of a memory system including non-volatile memory, such as solid state drives (SSDs), USB flash drives and phase change memories, which should erase a stored data to write a new data in the same memory cell. It is possible to provide a wear equalization mechanism that recognizes the extent to which a cell storing data is worn-out and provides various levels of life extension to such a memory system. Such a wear-leveling mechanism can be applied to an operation such as garbage collection (GC) in which new data may be programmed by releasing unnecessary area from a memory area previously allocated for programming a data.

Referring to FIG. 9, a memory system can move a large amount of data for wear leveling or garbage collection. The memory device 40 in the memory system may include a data block 40_1 in which data is stored and a free block 40_2 in which no data is stored. The controller 30a may read a data stored in the data block 40_1 and load the data in the memory 39 inside the controller 30a and then store the data loaded in the memory 39 in the free block 40_2. In a procedure of transferring a large amount of data from the data block 40_1 to the free block 40_2, the controller 30a can load metadata of the data to be moved, update the metadata after the data is moved, and store the updated metadata in the memory device 40.

When the metadata regarding a large amount of data is updated after the large amount of data has been successfully transferred, there might be no problem in operations where the host 10 exchanges a data with the memory system 20. However, if a large amount of data is not moved successfully, or if the metadata regarding the moved data is not updated successfully, it may be difficult for the memory system 20 to transmit data to the host 10 in response to a request entered from the host 10.

Since it takes a certain time to transfer a large amount of data in a memory system, an unexpected problem or issue may occur in the memory system in the process of transferring the large amount of data. The unexpected problem or issue may cause an undesirable result, e.g., an undesirable halt or stop of the process of transferring a large amount of data before completion of the process). By way of example but not limitation, a problem can arise in the process of moving a large amount of data (indicated by C) in FIG. 9). If the large amount of data cannot be transferred to the free block 40_2 due to an internal or external factor such as sudden power-off (SPO), the controller 30a can move the large amount of data later after the problem is solved (e.g., power is resupplied). The controller 30a may either start all over again or resume a specific process or step, after the problem is solved. Further, a problem may occur due to internal or external factors during the process of updating a metadata (indicated by C) in FIG. 9) after the large amount of data is transferred. In this case, when the internal or external factor disappears, the controller 30a needs to recover or restore the metadata in a way that the metadata is successfully updated.

In the memory system 20, the controller 30a can perform a data recovery process to correct an error even if an operation of transferring a large amount of data is abnormally halted or stopped. In general, all of data areas are scanned and the interrupted operations are identified in the memory system 20 during the data recovery operation. In this data recovery operation, a considerable time may be required for scanning all data areas. These may affect, aggravate or deteriorate performance and reliability of the memory system 20.

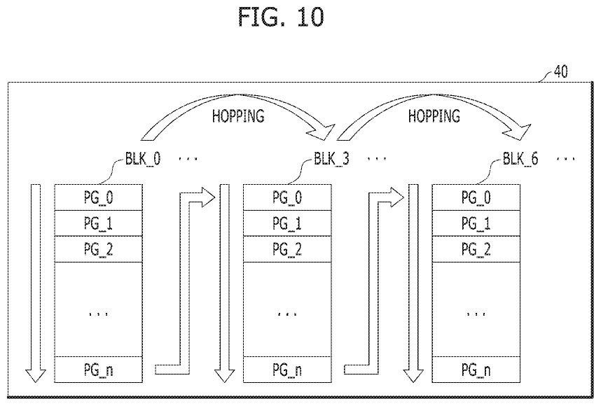

In FIG. 10, a method of selection and hopping between free blocks to program a large amount of data is illustrated in detail.

Referring to FIG. 10, it is assumed that voluminous data is stored in blocks BLK_0, BLK_3, BLK_6. The controller 30a can use a plurality of free blocks 40_2 for programming the voluminous data. For example, the controller 30a may sequentially program the voluminous data from a first page PG_0 of the first free block BLK_0 to the last page PG_n of the first free block BLK_0. The voluminous data is programmed from a first page PG_0 of the second free block BLK_3 to the last page PG_n of the second free block BLK_3 after the last page PG_n of the first free block BLK_0 is written. Continuously, the voluminous data can be programmed from the third free block BLK_6 after the last page PG_n of the second free block BLK_3 is written.

Blocks may not be programmed in a regular sequence from the first to the last. For example, programming the first block preferentially, i.e., more often than another block, may result in a greater difference in wear between the first block and other blocks. A block to be programmed may be determined or selected by various mechanisms for wear leveling, garbage collection or the like. For instance, like the first block BLK_0, the second block BLK_3 and the third block BLK_6 shown in FIG. 10, the controller 30a can hop among the plurality of free blocks to determine and select one or more blocks to be programmed.

To program voluminous data, the controller 30a can select some of the plurality of free blocks. Then, the controller 30a may sequentially program the voluminous data into selected free blocks. In connection with this discussion, it is assumed that power is undesirably interrupted in the memory device 40 after some of the voluminous data is programmed in the first and second free blocks BLK_0, BLK_3, but before the rest of the voluminous data is programmed in the third free block BLK_6.

Even if the power is interrupted and not supplied during a procedure of programming voluminous data so that the program operation is interrupted during programming in the third free block BLK_6, it may be hard for a memory system to smoothly continue the process of programming the voluminous data from or at an interrupted location or page of the third free block BLK_6, when the power is supplied again. This is because, when the power is supplied again, it is necessary to recognize the interrupted location through the full scan process of checking whether data is written from the first block to the third free block BLK_0, BLK_3, BLK_6 for a data recovery operation. Regardless of whether the controller 30a scans all of the blocks or the free blocks in the memory device 40, a considerable amount of time may be needed to determine where, within BLK_6, the operation of transferring the voluminous data was interrupted. However, if the controller 30a records the operation information regarding hopping between blocks, e.g., hopping information of when the process hopped from the first block BLK_0 to the second block BLK_3 (first hopping) and when the process hopped from the second block BLK_3 (second hopping) to the third block BLK_6, the controller 30a does not have to scan all blocks or free blocks in the memory device 40 to determine the location of interruption so that the time required for a data recovery operation may be reduced. The operation information may be recorded before power interruption. In an embodiment, the operation information may be stored in the memory device 40 before the voluminous data is programmed.

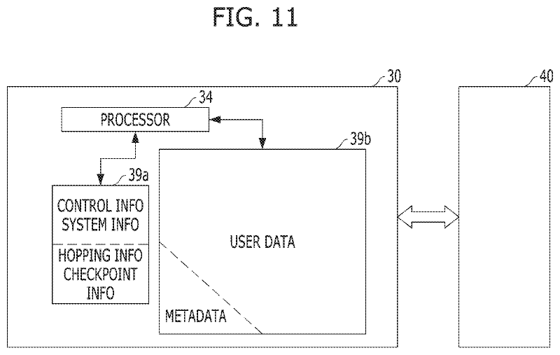

In FIG. 11, a controller 30 according to another embodiment of the disclosure is shown. The controller 30 and the memory device 40 are operably coupled so they may exchange instructions and data with each other.

Referring to FIG. 11, the controller 30 may include at least one processor 34 and at least one memory 39a and/or 39b. At least one processor 34 may perform foreground operations, such as a read operation, a program (write) operation or etc., each corresponding to a command or a data transmitted from the host 10. In addition, the processor 34 may perform a background operation such as wear levelling or garbage collection while the foreground operation is not requested or performed.

According to an embodiment, either or both of a first memory 39a for storing control information, system information, hopping information, checkpoint information and the like and a second memory 39b for storing user data, meta data, and the like may be used. Herein, the first memory 39a and the second memory 39b are classified according to types and characteristics of data stored therein.

According to an embodiment, the first memory 39a and the second memory 39b may be different memory devices which are physically distinguished from each other. In another embodiment, the first memory 39a and the second memory 39b may be two distinct areas included in a single memory device.

Further, according to an embodiment, the first memory 39a may include a nonvolatile memory element, and the second memory 39b may include a volatile memory element.

According to an embodiment, the first memory 39a and the second memory 39b may not be included in the controller 30 but may be included in the memory device 40. For example, when it is difficult to include a mass storage device (e.g., the first and/or second memories 39a and 39b) in the controller 30, the controller 30 can utilize a certain area in the memory device 40 for an operation such as a read operation, a write operation, a delete operation, and the like of data stored in another area of the memory device 40.

The first memory 39a may store operation information, e.g., hopping information, checkpoint information, and the like associated with an operation for programming voluminous data. Even if the operation for programming the voluminous data is interrupted, the controller 30 can recognize, based on the operation information stored in the first memory 39a, where the operation for programming the voluminous data is to be resumed when power is supplied again. When the power is supplied, the processor 34 can refer to the operation information in the first memory 39a so that the processor 34 does not need to scan all of the blocks to know at which block the operation was stopped. In an embodiment, the operation information may include first information regarding which operation was halted (e.g., checkpoint information) and second information regarding which block an operation has been proceeded or halted (e.g., hopping information or location information). Particularly, based on the operation information, it is possible that the processor 34 may recognize more quickly at which location or block the operation of programming the voluminous data was interrupted.

According to an embodiment, the first memory 39a may store the second information, e.g., hopping reference information and a physical block address of the first block in which the voluminous data is programmed. Herein, the hopping reference information may include a rule regarding how to hop between the free blocks to select one of blocks to be programmed by the voluminous data.

According to an embodiment, when power is supplied again, the controller 30 can determine a specific block in which an operation of programming the voluminous data is interrupted based on the check point information and the hopping information. Here, the hopping information may indicate a second block including an interrupted page following a first block based on the hopping reference information, which the programming of the voluminous data is completed to and corresponds to the checkpoint information, among selected or determined blocks to be allocated or assigned for the voluminous data.

On the other hand, according to an embodiment, even if the check point information does not exist or there is an error after the program operation of voluminous data is interrupted, the controller 30 may find the interrupted block for sequentially programming the voluminous data based on hopping information.

As described above, the controller 30 may include the processor 34 that performs either a foreground operation corresponding to an instruction transferred from the host or a background operation when a foreground operation is not performed, and the memory 39a and 39b for storing operation information used for determining which blocks are allocated for programming voluminous data having sizes that require at least two blocks among the plural blocks in the memory device 40. The processor 34 can resume a program operation based on the operation information recorded in the memory 39a and 39b after the program operation for the voluminous data is interrupted.

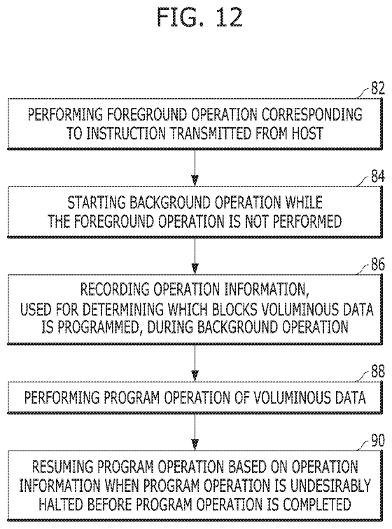

In FIG. 12, a method for operating a memory system according to another embodiment of the disclosure is illustrated.

Referring to FIG. 12, a method for operating a memory system can include performing a foreground operation corresponding to an instruction transmitted from a host (step 82), starting a background operation while the foreground operation is not performed (step 84), recording operation information, used for determining in which blocks voluminous data is programmed, during the background operation (step 86), performing a program operation of the voluminous data (step 88), and resuming the program operation based on the operation information when the program operation is undesirably halted before the program operation is completed (step 90). Herein, the voluminous data can have various sizes that require at least two blocks among plural blocks in a memory device.

The operation information for selecting some of the plurality of free blocks may include the hopping reference information representing a criterion required for sequentially hopping between at least two free blocks. According to an embodiment, the operation information may include an order of selected free blocks. In an embodiment, the operation information can include information regarding a physical block address of the first free block among selected free blocks and the hopping reference information representing rules on how to determine a hopping order among the selected free blocks. Such operation information can be determined and stored before the voluminous data is programmed.

Although not shown, the step 90 of resuming the program operation based on the operation information may include determining a specific block in which the program operation of the voluminous data is interrupted based on the checkpoint information and the operation information. Here, the checkpoint information may be used to reduce an amount of scanned log data, which includes records regarding operations performed inside the memory system. The checkpoint information regarding time and location of each operation, e.g., a block address, may be checked and recorded at various times, e.g., periodically. Thus, using the checkpoint information, the controller can return, after a sudden power off (SPO), the memory system to a specific operation point in time prior to the SPO, based on the checkpoint information. However, with the checkpoint information only, it might be difficult for the controller to recognize at which block among selected blocks an operation of programming voluminous data is stopped or halted due to a sudden power off (SPO), because the checkpoint information cannot show a next block to be programmed with some of the voluminous data. Therefore, if the operation information can provide information as to the block at which the operation of programming the voluminous data was interrupted due to the SPO, the memory system can easily find to what extent the operation of programming the voluminous data has been processed after a timing indicated by the checkpoint information. To this end, the operation information may indicate a second free block following a first free block corresponding to the checkpoint information among selected or determined free blocks allocated for the voluminous data. There is an interrupted page in the second free block while the first free block is completely programmed.

According to an embodiment, when no checkpoint information is found, or an error of the checkpoint information is found, after an operation for programming voluminous data is unexpectedly halted or stopped, operation information can indicate the interrupted block among blocks allocated for programming the voluminous data so that the controller may resume the operation of programming the rest of the voluminous data with reference to the interrupted block. When the controller starts the operation for programming the voluminous data, a count of free blocks allocated for the voluminous data and an order between the allocated free block can be determined. The order between the allocated free blocks may be recorded as the operation information.

According to an embodiment, the operation information may include a metadata regarding allocated blocks in which voluminous data is to be programmed. By way of example but not limitation, the operation information may include a physical block address of the first block (i.e., starting block) among blocks allocated for the voluminous data as well as the hopping reference information. In this case, the controller can restore an order of free blocks allocated to be programmed with the voluminous data, based on the physical block address of the first block and the hopping reference information (e.g., hopping criterion) included in the operation information, even though the controller does not record the order of the free blocks additionally.

As described above, a large amount of data in the memory system can be translocated for various purposes such as wear leveling and garbage collection. To transfer a large amount of data, the memory system can program a large amount of data, which may take some time. In this process, sudden power-off (SPO) may interrupt a program operation of the voluminous data. The resuming the program operation based on the operation information (step 90 shown in FIG. 12) may include a step of scanning a specific block indicated by the operation information instead of scanning an entire metadata area of the memory device, when a power is supplied again after the power is interrupted or not supplied undesirably. This greatly reduces the time spent for a data recovery operation, as compared with a general data recovery operation requiring scan all or plural blocks in a memory device. A quickly completed data recovery operation based on the operation information can improve or enhance operational stability and reliability of the memory system.

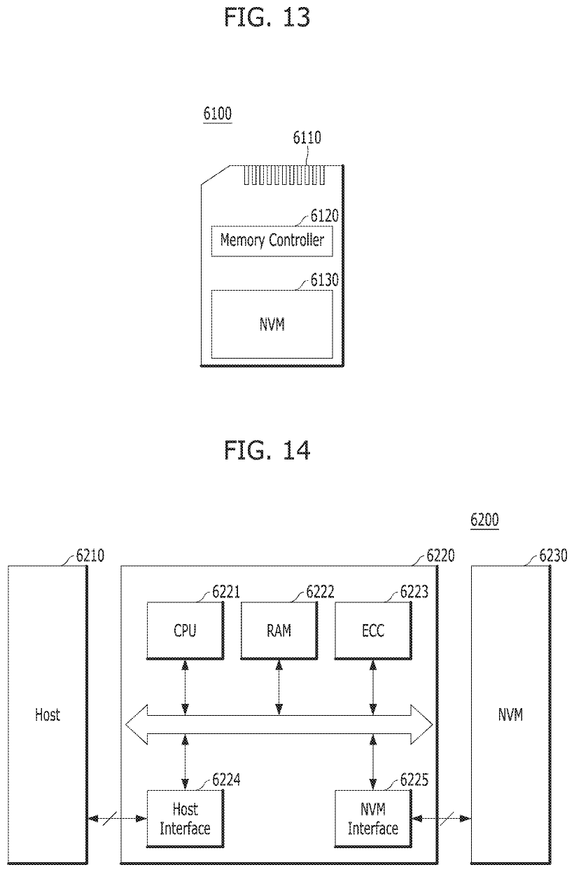

In FIG. 13, another example of the data processing system including the memory system in accordance with an embodiment is described. FIG. 13 schematically illustrates a memory card system to which the memory system is applied.

Referring to FIG. 13, the memory card system 6100 may include a memory controller 6120, a memory device 6130 and a connector 6110.

The memory controller 6120 may be connected to the memory device 6130 embodied by a nonvolatile memory. The memory controller 6120 may be configured to access the memory device 6130. By way of example and not limitation, the memory controller 6120 may be configured to control read, write, erase and background operations of the memory device 6130. The memory controller 6120 may be configured to provide an interface between the memory device 6130 and a host, and use a firmware for controlling the memory device 6130. That is, the memory controller 6120 may correspond to the controller 130 of the memory system 110 described with reference to FIGS. 1 and 2, and the memory device 6130 may correspond to the memory device 150 of the memory system 110 described with reference to FIGS. 1 and 5.

Thus, the memory controller 6120 may include a RAM, a processor, a host interface, a memory interface and an error correction component. The memory controller 6120 may further include the elements shown in FIGS. 1 and 2.

The memory controller 6120 may communicate with an external device, for example, the host 102 of FIG. 1 through the connector 6110. For example, as described with reference to FIG. 1, the memory controller 6120 may be configured to communicate with an external device according to one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system may be applied to wired/wireless electronic devices, particularly mobile electronic devices.

The memory device 6130 may be implemented by a nonvolatile memory. For example, the memory device 6130 may be implemented by any of various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM). The memory device 6130 may include a plurality of dies as in the memory device 150 of FIG. 7.

The memory controller 6120 and the memory device 6130 may be integrated into a single semiconductor device. For example, the memory controller 6120 and the memory device 6130 may be so integrated to form a solid state driver (SSD). In another embodiment, the memory controller 6120 and the memory device 6130 may be integrated to form a memory card such as a PC card (PCMCIA: Personal Computer Memory Card International Association), a compact flash (CF) card, a smart media card (e.g., a SM and a SMC), a memory stick, a multimedia card (e.g., a MMC, a RS-MMC, a MMCmicro and an eMMC), an SD card (e.g., a SD, a miniSD, a microSD and a SDHC) and/or a universal flash storage (UFS).

FIG. 14 is a diagram schematically illustrating another example of the data processing system including the memory system in accordance with an embodiment.

Referring to FIG. 14, the data processing system 6200 may include a memory device 6230 having one or more nonvolatile memories and a memory controller 6220 for controlling the memory device 6230. The data processing system 6200 illustrated in FIG. 14 may serve as a storage medium such as a memory card (CF, SD, micro-SD or the like) or USB device, as described with reference to FIGS. 1 and 2. The memory device 6230 may correspond to the memory device 150 in the memory system 110 illustrated in FIGS. 1 and 5. The memory controller 6220 may correspond to the controller 130 in the memory system 110 illustrated in FIGS. 1 and 2.

The memory controller 6220 may control a read, write or erase operation on the memory device 6230 in response to a request of the host 6210. The memory controller 6220 may include one or more CPUs 6221, a buffer memory such as RAM 6222, an ECC circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221. The RAM 6222 may be used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC circuit 6223 may correspond to the ECC component 138 of the controller 130 illustrated in FIG. 1. As described with reference to FIG. 1, the ECC circuit 6223 may generate an ECC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. The ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may exchange data with the host 6210 through the host interface 6224. The memory controller 6220 may exchange data with the memory device 6230 through the NVM interface 6225. The host interface 6224 may be connected to the host 6210 through a PATA bus, SATA bus, SCSI, USB, PCIe or NAND interface. The memory controller 6220 may have a wireless communication function with a mobile communication protocol such as WiFi or Long Term Evolution (LTE). The memory controller 6220 may be connected to an external device, for example, the host 6210 or another external device, and then exchange data with the external device. Particularly, as the memory controller 6220 is configured to communicate with the external device through one or more of various communication protocols, the memory system and the data processing system in accordance with an embodiment may be applied to wired/wireless electronic devices, particularly a mobile electronic device.

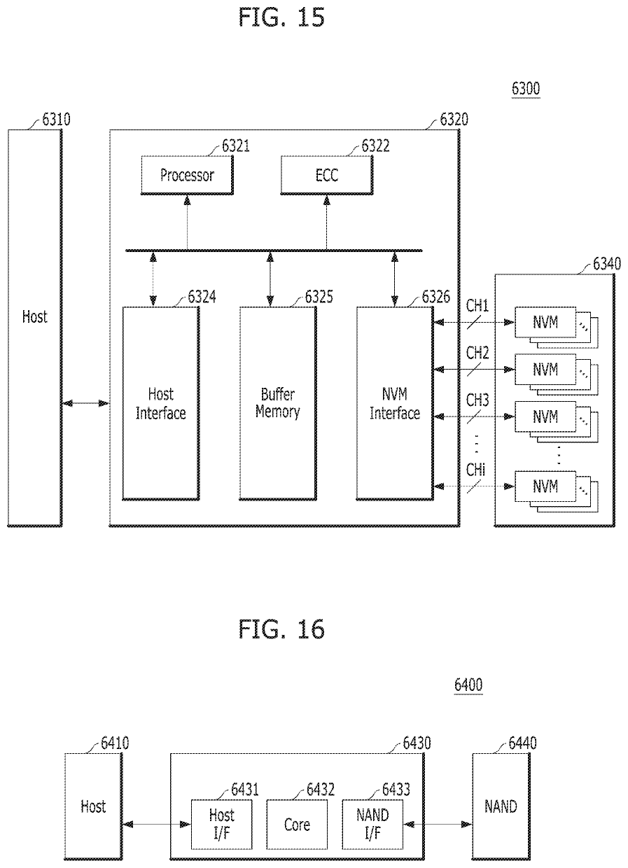

FIG. 15 is a diagram schematically illustrating another example of the data processing system including the memory system in accordance with an embodiment. FIG. 15 schematically illustrates an SSD to which the memory system is applied.

Referring to FIG. 15, the SSD 6300 may include a controller 6320 and a memory device 6340 including a plurality of nonvolatile memories. The controller 6320 may correspond to the controller 130 in the memory system 110 of FIGS. 1 and 2. The memory device 6340 may correspond to the memory device 150 in the memory system of FIGS. 1 and 5.

More specifically, the controller 6320 may be connected to the memory device 6340 through a plurality of channels CH1 to CHi. The controller 6320 may include one or more processors 6321, a buffer memory 6325, an ECC circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by any of various volatile memories such as DRAM, SDRAM, DDR SDRAM, LPDDR SDRAM and GRAM or nonvolatile memories such as FRAM, ReRAM, STT-MRAM and PRAM. FIG. 15 illustrates that the buffer memory 6325 is disposed in the controller 6320. However, the buffer memory 6325 may be disposed externally to the controller 6320.

The ECC circuit 6322 may calculate an ECC value of data to be programmed to the memory device 6340 during a program operation. The ECC circuit 6322 may perform an error correction operation on data read from the memory device 6340 based on the ECC value during a read operation. The ECC circuit 6322 may perform an error correction operation on data recovered from the memory device 6340 during a failed data recovery operation.

The host interface 6324 may provide an interface function with an external device, for example, the host 6310. The nonvolatile memory interface 6326 may provide an interface function with the memory device 6340 connected through the plurality of channels.

Furthermore, a plurality of SSDs 6300 to which the memory system 110 of FIGS. 1 and 2 is applied may be provided to embody a data processing system, for example, RAID (Redundant Array of Independent Disks) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300. The RAID controller may output data corresponding to the write command to the selected SSDs 6300. Furthermore, when the RAID controller performs a read operation in response to a read command provided from the host 6310, the RAID controller may select one or more memory systems or SSDs 6300 according to a plurality of RAID levels, that is, RAID level information of the read command provided from the host 6310 in the SSDs 6300. The RAID controller may provide data read from the selected SSDs 6300 to the host 6310.

FIG. 16 is a diagram schematically illustrating another example of the data processing system including the memory system in accordance with an embodiment. FIG. 16 schematically illustrates an embedded Multi-Media Card (eMMC) to which the memory system is applied.

Referring to FIG. 16, the eMMC 6400 may include a controller 6430 and a memory device 6440 embodied by one or more NAND flash memories. The controller 6430 may correspond to the controller 130 in the memory system 110 of FIGS. 1 and 2. The memory device 6440 may correspond to the memory device 150 in the memory system 110 of FIGS. 1 and 5.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400. The host interface 6431 may provide an interface function between the controller 6430 and the host 6410. The NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, UHS ((Ultra High Speed)-I/UHS-II) interface.

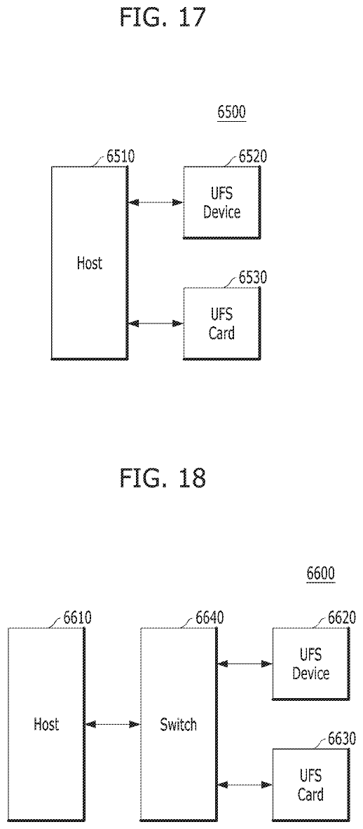

FIGS. 17 to 20 are diagrams schematically illustrating other examples of the data processing system including the memory system in accordance with embodiments. FIGS. 17 to 20 schematically illustrate UFS (Universal Flash Storage) systems to which the memory system is applied.

Referring to FIGS. 17 to 20, the UFS systems 6500, 6600, 6700, 6800 may include hosts 6510, 6610, 6710, 6810, UFS devices 6520, 6620, 6720, 6820 and UFS cards 6530, 6630, 6730, 6830, respectively. The hosts 6510, 6610, 6710, 6810 may serve as application processors of wired/wireless electronic devices or particularly mobile electronic devices, the UFS devices 6520, 6620, 6720, 6820 may serve as embedded UFS devices, and the UFS cards 6530, 6630, 6730, 6830 may serve as external embedded UFS devices or removable UFS cards.

The hosts 6510, 6610, 6710, 6810, the UFS devices 6520, 6620, 6720, 6820 and the UFS cards 6530, 6630, 6730, 6830 in the respective UFS systems 6500, 6600, 6700, 6800 may communicate with external devices, for example, wired/wireless electronic devices or particularly mobile electronic devices through UFS protocols, and the UFS devices 6520, 6620, 6720, 6820 and the UFS cards 6530, 6630, 6730, 6830 may be embodied by the memory system 110 illustrated in FIGS. 1 and 2. For example, in the UFS systems 6500, 6600, 6700, 6800, the UFS devices 6520, 6620, 6720, 6820 may be embodied in the form of the data processing system 6200, the SSD 6300 or the eMMC 6400 described with reference to FIGS. 14 to 16, and the UFS cards 6530, 6630, 6730, 6830 may be embodied in the form of the memory card system 6100 described with reference to FIG. 13.

Furthermore, in the UFS systems 6500, 6600, 6700, 6800, the hosts 6510, 6610, 6710, 6810, the UFS devices 6520, 6620, 6720, 6820 and the UFS cards 6530, 6630, 6730, 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720, 6820 and the UFS cards 6530, 6630, 6730, 6830 may communicate with each other through various protocols other than the UFS protocol, for example, an UFDs, a MMC, a SD, a mini-SD, and a micro-SD.

In the UFS system 6500 illustrated in FIG. 17, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. The UFS device 6520 and the UFS card 6530 may communicate with each other through link layer switching at the UniPro of the host 6510. In the embodiment of FIG. 17, the configuration in which one UFS device 6520 and one UFS card 6530 are connected to the host 6510 is illustrated by way of example. However, in another embodiment, a plurality of UFS devices and UFS cards may be connected in parallel or in the form of a star to the host 6510. The form of a star is an arrangement where a single centralized component is coupled to plural devices for parallel processing. A plurality of UFS cards may be connected in parallel or in the form of a star to the UFS device 6520 or connected in series or in the form of a chain to the UFS device 6520.

In the UFS system 6600 illustrated in FIG. 18, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the embodiment of FIG. 18, the configuration in which one UFS device 6620 and one UFS card 6630 are connected to the switching module 6640 is illustrated by way of example. However, in another embodiment, a plurality of UFS devices and UFS cards may be connected in parallel or in the form of a star to the switching module 6640, and a plurality of UFS cards may be connected in series or in the form of a chain to the UFS device 6620.

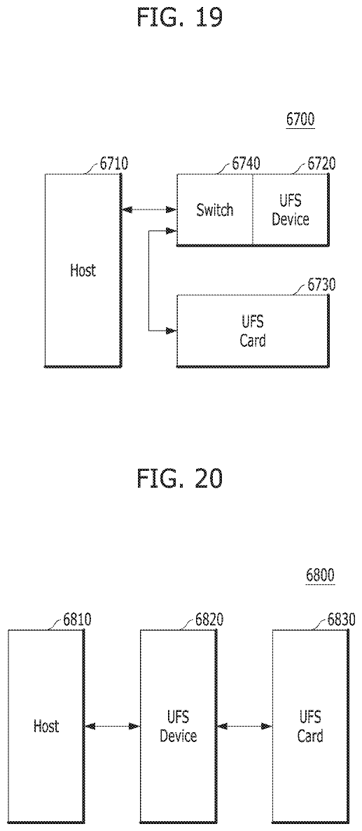

In the UFS system 6700 illustrated in FIG. 19, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. The UFS device 6720 and the UFS card 6730 may communicate with each other through link layer switching of the switching module 6740 at the UniPro, and the switching module 6740 may be integrated as one module with the UFS device 6720 inside or outside the UFS device 6720. In the embodiment of FIG. 19, the configuration in which one UFS device 6720 and one UFS card 6730 are connected to the switching module 6740 is illustrated by way of example. However, in another embodiment, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 20, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. The host 6810 and the UFS card 6830 may communicate with each other through target ID switching between the M-PHY and UniPro modules of the UFS device 6820. In the embodiment of FIG. 20, the configuration in which one UFS device 6820 is connected to the host 6810 and one UFS card 6830 is connected to the UFS device 6820 is illustrated by way of example. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

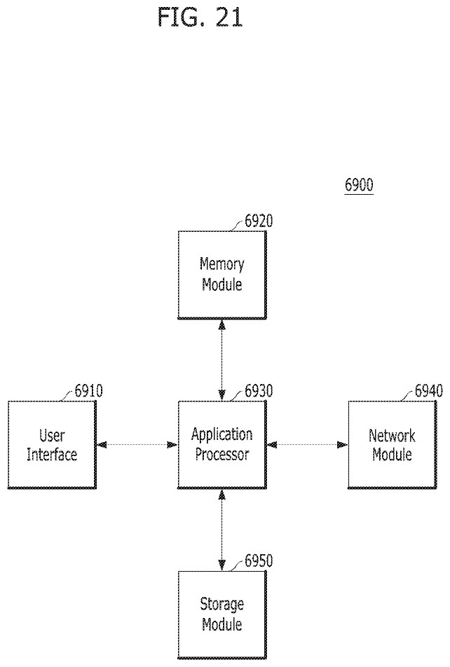

FIG. 21 is a diagram schematically illustrating another example of the data processing system including the memory system in accordance with an embodiment of the present invention. FIG. 21 is a diagram schematically illustrating a user system to which the memory system is applied.

Referring to FIG. 21, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile RAM such as DRAM, SDRAM, DDR SDRAM, DDR2 SDRAM, DDR3 SDRAM, LPDDR SDARM, LPDDR3 SDRAM or LPDDR3 SDRAM or a nonvolatile RAM such as PRAM, ReRAM, MRAM or FRAM. For example, the application processor 6930 and the memory module 6920 may be packaged and mounted, based on POP (Package on Package).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, a NOR flash and a 3D NAND flash, and provided as a removable storage medium such as a memory card or external drive of the user system 6900. The storage module 6950 may correspond to the memory system 110 described with reference to FIGS. 1 and 2. Furthermore, the storage module 6950 may be embodied as an SSD, an eMMC and an UFS as described above with reference to FIGS. 15 to 20.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a monitor.

Furthermore, when the memory system 110 of FIGS. 1 and 2 is applied to a mobile electronic device of the user system 6900, the application processor 6930 may control overall operations of the mobile electronic device. The network module 6940 may serve as a communication module for controlling wired/wireless communication with an external device. The user interface 6910 may display data processed by the application processor 6930 on a display/touch module of the mobile electronic device. Further, the user interface 6910 may support a function of receiving data from the touch panel.

The memory system and the operating method thereof according to embodiments may minimize complexity and performance deterioration of the memory system and maximize utilization efficiency of a memory device, thereby quickly and stably process data with respect to the memory device.

In an embodiment, a memory system, a data processing system, and a method for checking or recovering an operation thereof may be configured such that, when undesirably halting an operation of moving or programming a large amount of data due to an external factor such as a power supply interruption or another interruption and not completing the operation, the operation can be smoothly continued without a full-scanning data recovery process at the time when the external factor is removed.

Further, an embodiment can improve or enhance operational stability and reliability in a memory system capable of programming a large amount of data (voluminous data).

While the disclosure illustrates and describes specific embodiments, it will be apparent to those skilled in the art in light of the present disclosure that various changes and modifications may be made without departing from the spirit and scope of the invention as defined in the following claims.

1. A memory system, comprising:
a memory device including plural blocks, each capable of storing data; and
a controller suitable for:
recording operation information used for determining which blocks among the plural blocks voluminous data is to be programmed,
performing a program operation of the voluminous data, and
resuming the program operation based on the operation information after the program operation is halted,
wherein the voluminous data has a size that requires at least two blocks among the plural blocks.

2. The memory system according to claim 1, wherein the operation information includes a reference regarding how to determine a hopping sequence of the at least two blocks.

3. The memory system according to claim 1, wherein the controller determines a specific block, among the at least two blocks, in which the program operation is halted based on check point information and the operation information.

4. The memory system according to claim 3, wherein the operation information designates a second block following a first block corresponding to the check point information.

5. The memory system according to claim 1, wherein the operation information shows a sequence of the at least two blocks for programming the voluminous data after the program operation is halted, even when check point information does not exist or does include an error.

6. The memory system according to claim 1, wherein the operation information includes metadata regarding the at least two blocks in which the voluminous data is programmed.

7. The memory system according to claim 1, wherein the operation information includes a hopping rule and a first block address between the at least two blocks.

8. The memory system according to claim 1, wherein halt of the program operation is caused by a sudden power-off (SPO).

9. The memory system according to claim 8, wherein the controller scans a specific block, among the at least two blocks, indicated by the operation information, instead of scanning all metadata in the memory device, when power is provided after the sudden power-off.

10. The memory system according to claim 1, wherein the program operation is performed during a background operation for a wear leveling of the memory device.

11. A method for operating a memory system, comprising:
recognizing a request or a task for programming voluminous data; recording operation information, used for determining which blocks among plural blocks of the memory system the voluminous data is to be programmed, wherein the voluminous data has a size that requires the at least two blocks among plural blocks in a memory device;
performing a program operation of the voluminous data; and
resuming the program operation based on the operation information after the program operation is halted before the program operation is completed.

12. The method according to claim 11, wherein the operation information includes a reference regarding how to determine a hopping sequence of the at least two blocks.

13. The method according to claim 11, wherein the resuming the program operation includes
determining a specific block, among the at least two blocks, in which the program operation is halted based on check point information and the operation information.

14. The method according to claim 13, wherein the operation information designates a second block following a first block corresponding to the check point information.

15. The method according to claim 11, wherein the operation information shows a sequence of the at least two blocks for programming the voluminous data after the program operation is halted, even when check point information does not exist or does include an error.

16. The method according to claim 11, wherein the operation information includes metadata regarding the at least two blocks in which the voluminous data is programmed.

17. The method according to claim 11, wherein the operation information includes a hopping rule and a first block address between the at least two blocks.

18. The method according to claim 11, wherein halt of the program operation is caused by a sudden power-off (SPO).

19. The method according to claim 18, wherein the resuming the program operation includes
scanning a specific block, among the at least two blocks, indicated by the operation information, instead of scanning all metadata in the memory device, when a power is provided after the sudden power-off.

20. An apparatus controlling a non-volatile memory device, comprising:
a processor suitable for performing a foreground operation in response to a command or starting a background operation while the foreground operation is not performed; and
a storage device suitable for recording operation information, used for determining which blocks among plural blocks of the non-volatile memory device voluminous data is to be programmed,
wherein the processor performs a program operation of the voluminous data and resumes the program operation based on the operation information after the program operation is halted before the program operation is completed, and
wherein the voluminous data has a size that requires the at least two blocks among the plural blocks.
